(19) United States
(12) Patent Application Publication
(10) Pub. No.: US 2023/0336058 A1
(43) Pub. Date: Oct. 19, 2023

(54) METHOD OF MANUFACTURING STATOR FOR ROTARY ELECTRIC MACHINE, AND TUBULAR-SHAPED TOOL USED IN THE MANUFACTURING METHOD

(71) Applicant: TOYOTA JIDOSHA KABUSHIKI KAISHA, Toyota-shi (JP)

(72) Inventors: Keisuke ITO, Toyota-shi (JP); Satoshi IMAI, Kasugai-shi (JP)

(73) Assignee: TOYOTA JIDOSHA KABUSHIKI KAISHA, Toyota-shi (JP)

(21) Appl. No.: 18/301,370

(22) Filed: Apr. 17, 2023

(30) Foreign Application Priority Data
Apr. 19, 2022 (JP) 2022-069104

(51) Int. Cl. H02K 15/00

(52) U.S. Cl. CPC H02K 15/0087

(57) ABSTRACT

A method of manufacturing a stator for a rotary electric machine. The stator includes a stator core and coil segments including protruding portions that are twisted by a first twist angle, except small-twisted protruding portions which are ones of the protruding portions and which are twisted by a second twist angle that is smaller than the first twist angle. The method is executed by using a tubular-shaped tool having engaging grooves having a first groove width, except small-twisting engaging grooves which are ones of the engaging grooves and which have a second groove width that is larger than the first groove width. The tubular-shaped tool is spirally rotated relative to the stator core, with the protruding portions being inserted in the engaging grooves except the small-twisted protruding portions that is inserted in the small-twisting engaging grooves, whereby the protruding portions including the small-twisted protruding portions are concurrently twisted.

This application claims priority from Japanese Patent Application No. 2022-069104 filed on Apr. 19, 2022, the disclosure of which is herein incorporated by reference in its entirety.

### FIELD OF THE INVENTION

The present invention relates to a method of manufacturing a stator for a rotary electric machine and a tubular-shaped tool used in the manufacturing method, particularly, to techniques of twisting coil segments that constitute a stator coil of the stator.

### BACKGROUND OF THE INVENTION

There is known a stator for a rotary electric machine, wherein the stator includes: (i) a stator core having a tubular shape and provided with a multiplicity of slots that are formed in an inner peripheral portion of the stator core such that the slots extend in an axial direction of the stator core and are spaced apart from each other at a constant angular interval in a circumferential direction of the stator core; and (ii) a multiplicity of coil segments each having a generally U shape so as to include a pair of straight extending portions that are received in respective different ones of the slots such that the straight extending portions include respective protruding portions protruding out from the stator core in the axial direction, wherein the protruding portions of the respective straight extending portions are twisted about an axis of the stator core, and wherein distal end portions of the respective protruding portions are joined to each other, whereby a stator coil is formed. Further, there is proposed a method of manufacturing such a stator, by using a tubular-shaped tool having a multiplicity of engaging grooves which are spaced apart from each other in a circumferential direction of the tubular-shaped tool. The method includes: (a) positioning the tubular-shaped tool coaxially with the stator core such that the distal end portions of the respective protruding portions are inserted in the engaging grooves of the tubular-shaped tool; and (b) rotating the tubular-shaped tool about the axis relative to the stator core and moving the tubular-shaped tool toward the stator core in the axial direction, such that the protruding portions are concurrently twisted about the axis in a predetermined direction by a predetermined first twist angle. For example, JP-2020-110025A discloses such a method for of manufacturing the stator.

In JP-2020-110025A, the protruding portions include small-twisted protruding portions that are twisted about the axis by a predetermined second twist angle that is smaller than the first twist angle by a slot interval angle corresponding to the constant angular interval of the slots. Therefore, a preforming step is required to twist the small-twisted protruding portions by the slot interval angle in a direction opposite to the above-described predetermined direction, and after the preforming step, all of the protruding portions including the small-twisted protruding portions are concurrently twisted in the predetermined direction by the first twist angle by using the above-described tubular-shaped tool (see FIGS. 11-13 of the above-identified Japanese Patent Application Publication).

### SUMMARY OF THE INVENTION

However, where the protruding portions include the small-twisted protruding portions, the above-described preforming step is required to twist the small-twisted protruding portions in the opposite direction, so that the manufacturing cost is problematically increased due to the additionally required tool and step.

The present invention was made in view of the background art described above. It is therefore an object of the present invention to make it possible to twist all of the protruding portions concurrently by using the tubular-shaped tool that are common to all of the protruding portions, without need of a preforming step, in a case in which the protruding portions include the small-twisted protruding portions that are to be twisted by a smaller twist angle.

The object indicated above is achieved according to the following aspects of the present invention.

According to a first aspect of the invention, there is provided a method of manufacturing a stator for a rotary electric machine. The stator includes: (i) a stator core having a tubular shape and provided with a multiplicity of slots that are formed in an inner peripheral portion of the stator core such that the slots extend in an axial direction of the stator core and are spaced apart from each other at a constant angular interval in a circumferential direction of the stator core; and (ii) a multiplicity of coil segments each having a generally U shape so as to include a pair of straight extending portions that are received in respective different ones of the slots such that the straight extending portions include respective protruding portions protruding from the slots in the axial direction, wherein the protruding portions of the respective straight extending portions of the multiplicity of coil segments are twisted about an axis of the stator core by a predetermined first twist angle, except small-twisted protruding portions which are ones of the protruding portions and which are twisted about the axis by a predetermined second twist angle that is smaller than the first twist angle by a slot interval angle corresponding to the constant angular interval of the slots, and wherein distal end portions of the respective protruding portions of the respective coil segments are joined to each other, whereby a stator coil is formed. The method is executed by using a tubular-shaped tool having a multiplicity of engaging grooves which are spaced apart from each other in a circumferential direction of the tubular-shaped tool, and which have a first groove width as measured in the circumferential direction of the tubular-shaped tool, except small-twisting engaging grooves which are ones of the engaging grooves and which have a second groove width as measured in the circumferential direction of the tubular-shaped tool, such that the second groove width is larger than the first groove width, and such that the small-twisting engaging grooves have respective engaging surfaces. The method includes: (a) positioning the tubular-shaped tool coaxially with the stator core, such that the distal end portions of the respective protruding portions are to be inserted in the engaging grooves of the tubular-shaped tool, and such that the distal end portions of the respective small-twisted protruding portions as the ones of the protruding portions are to be inserted in the small-twisting engaging grooves as the ones of the engaging grooves, and (b) rotating the tubular-shaped tool about the axis relative to the stator core and moving the tubular-shaped tool toward the stator core in the axial direction, such that the protruding portions are concurrently twisted about the axis by the first twist angle, except the small-twisted protruding portions that are twisted about the axis by the second twist angle. When the tubular-shaped tool has been rotated relative to the stator core by the slot interval angle, the protruding portions are twisted by the first twist angle with the protruding portions being engaged with the engaging grooves, except the small-twisted protruding portions that are twisted by the second twist angle with the small-twisted protruding portions being engaged with the engaging surfaces of the small-twisting engaging grooves.

According to a second aspect of the invention, in the method according to the first aspect of the invention, the small-twisting engaging grooves have respective positioning protrusions provided in groove bottoms thereof, such that each of the positioning protrusions is spaced apart from a corresponding one of the engaging surfaces of the small-twisting engaging grooves by a distance corresponding to a width of each of the distal end portions of the respective small-twisted protruding portions, wherein, when the tubular-shaped tool has been rotated relative to the stator core by the slot interval angle, the distal end portions of the respective small-twisted protruding portions are inserted between the engaging surfaces and the positioning protrusions so as to be positioned in a predetermined position relative to the tubular-shaped tool, whereby the small-twisted protruding portions are twisted with the distal end portions of the respective small-twisted protruding portions being constrained between the engaging surfaces and the positioning protrusions.

According to a third aspect of the invention, there is provided a tubular-shaped tool to be used for manufacturing a stator for a rotary electric machine. The stator includes: (i) a stator core having a tubular shape and provided with a multiplicity of slots that are formed in an inner peripheral portion of the stator core such that the slots extend in an axial direction of the stator core and are spaced apart from each other at a constant angular interval in a circumferential direction of the stator core; and (ii) a multiplicity of coil segments each having a generally U shape so as to include a pair of straight extending portions that are received in respective different ones of the slots such that the straight extending portions include respective protruding portions protruding from the slots in the axial direction, wherein the protruding portions of the respective straight extending portions of the multiplicity of coil segments are twisted about an axis of the stator core by a predetermined first twist angle, except small-twisted protruding portions which are ones of the protruding portions and which are twisted about the axis by a predetermined second twist angle that is smaller than the first twist angle by a slot interval angle corresponding to the constant angular interval of the slots, and wherein distal end portions of the respective protruding portions of the respective coil segments are joined to each other, whereby a stator coil is formed. The tubular-shaped tool includes a multiplicity of engaging grooves which are spaced apart from each other in a circumferential direction of the tubular-shaped tool, and which have a first groove width as measured in the circumferential direction of the tubular-shaped tool, except small-twisting engaging grooves which are ones of the engaging grooves and which have a second groove width as measured in the circumferential direction of the tubular-shaped tool, such that the second groove width is larger than the first groove width, and such that the small-twisting engaging grooves have respective engaging surfaces. The tubular-shaped tool is to be positioned coaxially with the stator core such that the distal end portions of the respective protruding portions are to be inserted in the engaging grooves of the tubular-shaped tool, and such that the distal end portions of the respective small-twisted protruding portions as the ones of the protruding portions are to be inserted in the small-twisting engaging grooves as the ones of the engaging grooves, and is to be rotated about the axis relative to the stator core and moved toward the stator core in the axial direction, such that the protruding portions are concurrently twisted about the axis by the first twist angle, except the small-twisted protruding portions that are twisted about the axis by the second twist angle. When the tubular-shaped tool has been rotated relative to the stator core by the slot interval angle, the protruding portions are twisted by the first twist angle with the protruding portions being engaged with the engaging grooves, except the small-twisted protruding portions that are twisted by the second twist angle with the small-twisted protruding portions being engaged with the engaging surfaces of the small-twisting engaging grooves. The small-twisting engaging grooves have respective positioning protrusions provided in groove bottoms thereof, such that each of the positioning protrusions is spaced apart from a corresponding one of the engaging surfaces of the small-twisting engaging grooves by a distance corresponding to a width of each of the distal end portions of the respective small-twisted protruding portions. When the tubular-shaped tool has been rotated relative to the stator core by the slot interval angle, the distal end portions of the respective small-twisted protruding portions are inserted between the engaging surfaces and the positioning protrusions so as to be positioned in a predetermined position relative to the tubular-shaped tool.

According to a fourth aspect of the invention, in the tool according to the third aspect of the invention, the second groove width of the small-twisting engaging grooves is larger than the first groove width of the engaging grooves by a width corresponding to the slot interval angle.

In the method according to the first aspect of the invention, the method is executed by using the tubular-shaped tool having the multiplicity of engaging grooves which have the first groove width, except the small-twisting engaging grooves which have the second groove width larger than the first groove width, such that the distal end portions of the respective protruding portions are to be inserted in the engaging grooves of the tubular-shaped tool, and such that the distal end portions of the respective small-twisted protruding portions are to be inserted in the small-twisting engaging grooves. With the tubular-shaped tool being rotated about the axis relative to the stator core and being moved toward the stator core in the axial direction, the protruding portions are concurrently twisted about the axis by the first twist angle, except the small-twisted protruding portions that are twisted about the axis by the second twist angle. That is, where the protruding portions include the small-twisted protruding portions that are to be twisted by a twist angle smaller than the other protruding portions, all of the protruding portions including the small-twisted protruding portions can be concurrently twisted by using the tubular-shaped tool as a tool common to all of the protruding portions, without need of a preforming step, so that the manufacturing cost can be suppressed owing to reductions of required tools and required manufacturing steps.

In the method according to the second aspect of the invention, the small-twisting engaging grooves have the respective positioning protrusions provided in the groove bottoms thereof, so that, when the tubular-shaped tool has been rotated relative to the stator core by the slot interval angle, the distal end portions of the respective small-twisted protruding portions are inserted between the engaging surfaces and the positioning protrusions and are twisted with the distal end portions of the respective small-twisted protruding portions being constrained between the engaging surfaces and the positioning protrusions. Thus, the small-twisted protruding portions including the distal end portions can be appropriately twisted to have desired shapes.

The tubular-shaped tool according to the third aspect of the invention is to be used in the manufacturing method according to each of the first and second aspects of the invention, and provides substantially the same effects as the first and second aspects of the invention.

### BRIEF DESCRIPTION OF THE DRAWINGS

FIG. 1 is a perspective view schematically showing a construction of a stator for a rotary electric machine that is to be provided in an electrically driven vehicle, wherein the stator is manufactured in accordance with a manufacturing method according to an embodiment of the present invention;

FIG. 2 is a view for explaining a state in which a single coil segment is inserted in slots of a stator core of the stator of FIG. 1, wherein the view is a development view of an inner circumferential surface of the stator core around an axis C;

FIG. 3 is a view for explaining radially outermost ones of protruding portions protruding out from the stator core in which the multiplicity of coil segments are disposed, wherein the view is a development view of an outer circumferential surface of the stator core around the axis C;

FIG. 4 is a development view showing a state in which the protruding portions shown in FIG. 3 have been twisted about the axis C by a twisting step;

FIG. 5 is a perspective view for explaining a crown-shaped tool used in the twisting step; and

FIG. 6 is a set of views for explaining the twisting step in which the crown-shaped tool of FIG. 5 is used to concurrently perform two kinds of twistings that are different in terms of twist angle.

### DETAILED DESCRIPTION OF PREFERRED EMBODIMENT

The rotary electric machine is referred also to as a rotating machine, and may be an electric motor, an electric power generator, or a motor generator that can be used selectively as the electric motor or the electric power generator. The rotating electric machine is, for example, a three-phase AC synchronous motor of permanent-magnet embedded type. The present invention is advantageously applied to a stator for a rotary electric machine for an electrically driven vehicle, which is to be used as a drive power source for driving the electrically driven vehicle such as an electric vehicle and a hybrid electric vehicle. However, the present invention is applicable also to technique for manufacturing a stator for any one of various kinds of rotary electric machines such as an electric power generator for a series-type hybrid electric vehicle and also an electric motor and an electric power generator that are to be used for a device or machine other than a vehicle. The first twist angle, by which the protruding portions of the coil segments are to be twisted, corresponds to an angle three times as large as the slot interval angle, so that the second twist angle corresponds to an angle twice as large as the slot angle, for example. However, the first and second twist angles may be changed to other degrees, as needed, as long as the second twist angle is smaller than the first twist angle by the slot interval angle.

The second groove width of the small-twisting engaging grooves of the tubular-shaped tool is larger than the first groove width of the engaging grooves of the tubular-shaped tool, by a width corresponding to the slot interval angle, for example. However, the second groove width may be larger than a sum of the first groove width and the width corresponding to the slot interval angle. Further, a protruding distance of each of the small-twisted protruding portions, which are to be engaged in the small-twisting engaging grooves so as to be twisted, can be reduced because the twist angle is small, so that the second groove width may be also smaller than the sum of the first groove width and the width corresponding to the slot interval angle, as long as the small-twisting engaging grooves do not interfere with the small-twisted protruding portions. It is preferable that the small-twisting engaging grooves have the respective positioning protrusions provided in the groove bottoms thereof to position the distal end portions of the small-twisted protruding portions. However, the positioning protrusions may be omitted. Where the positioning protrusions are not provided, it is possible to use another jig or tool for regulating a twisted shape of the small-twisted protruding portions, or to execute a post-processing for forming a desired shape of the small-twisted protruding portions. Moreover, even where the positioning protrusions are provided, such another jig or tool may be used or such a post-processing may be executed, as needed.

### Embodiment

There will be described an embodiment of the present invention in details with reference to drawings. It is noted that figures of the drawings are simplified or deformed as needed, and each portion is not necessarily precisely depicted in terms of dimension ratio, shape, angle, etc, for easier understanding of the embodiment.

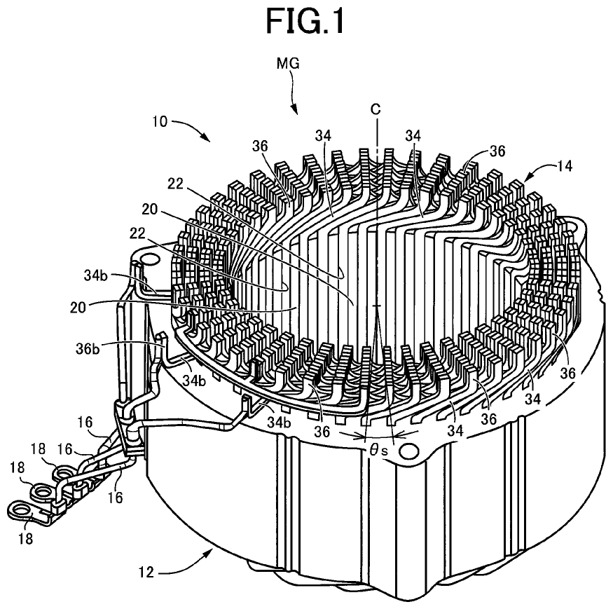

FIG. 1 is a perspective view schematically showing a construction of a stator 10 for a rotary electric machine MG to which the present invention is applied. The rotary electric machine MG is a motor generator used as a drive power source for an electrically driven vehicles such as a hybrid electric vehicle and an electric vehicle, and is a three-phase AC synchronous motor, for example. The rotary electric machine MG incudes a cylindrical-tubular-shaped stator 10 and a rotor (not shown) disposed on an inner peripheral side of the stator 10, such that the stator 10 and the rotor are rotatable relative to each other about an axis C that are common to the stator 10 and the rotor. The stator 10 is a stator for a rotary electric machine.

The stator 10 includes a cylindrical-tubular-shaped stator core 12 coaxial with the axis C, a stator coil 14 and power lines 16. The stator core 12 is constituted by a multiplicity of annular-shaped steel plates that are laminated on each other in an axial direction parallel to the axis C such that each of the steel plates has an attitude perpendicular to the axis C. The stator core 12 has a plurality of teeth 20 provided in its inner circumferential surface such that the teeth 20 extend in parallel with the axis C and are spaced apart from each other at a constant angular interval in a circumferential direction around the axis C. Each pair of the teeth 20, which are adjacent to each other in the circumferential direction around the axis C, cooperate with each other to define therebetween a slot 22 that is a groove-shaped void, so that the teeth 20 and the slots 22 are alternately arranged in the circumferential direction. The stator coil 14 is wound on the teeth 20, and is stored in the slots 22. The slots 22 are spaced apart from each other at the same angular interval as the teeth 20. In the following description, this same angular interval will be referred to as “slot interval angle θs”.

In the present embodiment, the stator coil 14 is a three-phase winding of U-phase, V-phase and W-phase, and each phase portion of the stator coil 14 is electrically connected at its end portion to a corresponding one of the power lines 16. The power lines 16 are connected at their distal end portions to respective external terminals 18, for connection with an inverter (not shown). The stator coil 14 is a distributed winding that is wound over the plurality of teeth 20, and is connected by a Y connection.

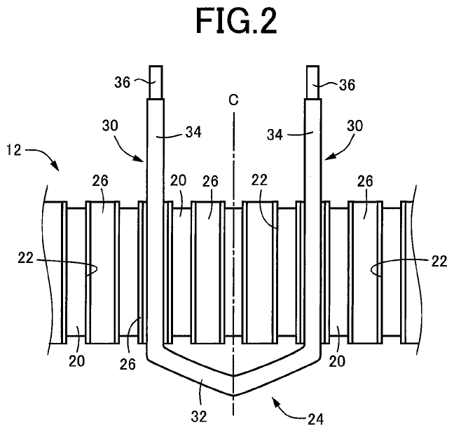

The stator coil 14 is constituted by a plurality of coil segments 24, one of which is shown in FIG. 2. FIG. 2 is a view showing a state in which a single one of the coil segments 24 is inserted in the slots 22 provided in the stator core 12, wherein the view of FIG. 2 is a development view of an inner circumferential surface of the stator core 12 around the axis C. An insulating material 26 such as a foam insulating paper is provided in advance on an inner circumferential surface of each of the slots 22. Each of the coil segments 24 has a generally U shape, so as to include a pair of straight extending portions 30 that are parallel to each other and a U-shaped turning portion 32 connecting between the pair of straight extending portions 30. The pair of straight extending portions 30 of each coil segment 24 are received in respective different ones of the slots 22, such that each of the straight extending portions 30 has an attitude parallel to the axis C. Each of the coil segments 24 is provided in the stator core 12 such that the straight extending portions 30 protrude from the slots 22 in an upward direction as seen in FIG. 2, i.e., one of opposite directions parallel to the axis C, while the U-shaped turning portion 32 protrudes from the slots 22 in a downward direction as seen in FIG. 2, i.e., the other of the opposite directions parallel to the axis C. In the multiplicity of slots 22 around the axis C, the multiplicity of coil segments 24 are disposed such that the coil segments 24 are offset from each other in the circumferential direction around the axis C and a radial direction of the stator core 12.

The straight extending portions 30 of the multiplicity of coil segments 24 include respective protruding portions 34 protruding from the slots 22 in the axial direction of the stator core 12, wherein the protruding portions 34 of the respective straight extending portions 30 are twisted about the axis C in the circumferential direction of the stator core 12, and wherein distal end portions 36 of the respective protruding portions 34 of each adjacent two of the coil segments 24, which are adjacent to each other in the radial direction, are superposed on each other and are joined to each other, as shown in FIG. 1. That is, each two of the protruding portions 34, which are adjacent to each other in the radial direction, are twisted in respective direction opposite to each other in the circumferential direction about the axis C, and the distal end portions 36 of the respective protruding portions 34 of each adjacent two of the coil segments 24, which are adjacent to each other in the radial direction, are jointed to each other, whereby the stator coil 14 wound across the plurality of teeth 20 is formed. As shown in FIG. 1, radially innermost ones of the protruding portions 34 are twisted in clockwise direction as seen from above in FIG. 1, and the twist direction is alternately inverted as seen in the radial direction, such that radially outermost ones of the protruding portions 34 are twisted in counterclockwise direction as seen from above in FIG. 1. The radially outermost ones of the protruding portions 34 can be interpreted to cooperate with one another to constitute a radially outermost layer that is an eighth layer as counted from a radially innermost layer that can be interpreted to be constituted by cooperation of the above-described innermost ones of the protruding portions 34. Each of the coil segments 24 is constituted by an elongated conductor plate having a rectangular cross-sectional shape, such that an insulation film made of enamel or the like is provided to cover a surface of the rectangular conductor. The distal end portions 36 of the respective protruding portions 34 are not covered with the insulation film, and are jointed to each other by welding.

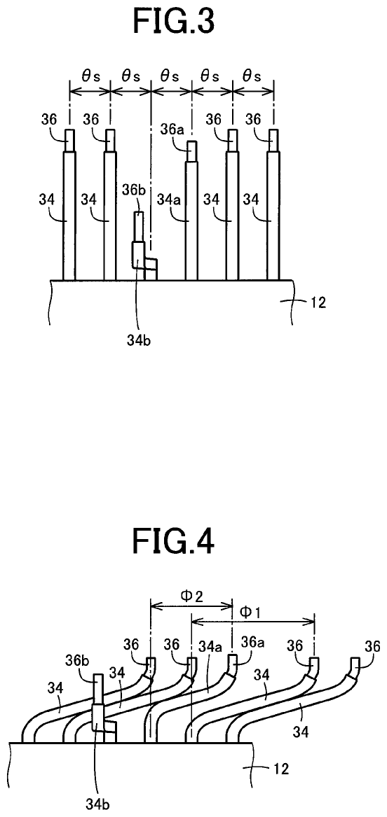

FIG. 3 is a view for explaining the radially outermost ones of the protruding portions 34 protruding from the stator core 12 in which the multiplicity of coil segments 24 are disposed, wherein the view of FIG. 3 is a development view of an outer circumferential surface of the stator core 12 around the axis C. FIG. 3 shows a stage before a twisting step is performed for the protruding portions 34, and FIG. 4 shows a stage after the twisting step has been performed for the protruding portions 34. As is clear from FIGS. 3 and 4, power-line-connection protruding portions 34b, which are ones of the protruding portions 34, are bent outwardly (toward front side of drawing sheet of each of FIGS. 3 and 4) in the radial direction of the stator core 12, prior to the twisting step, so that the power-line-connection protruding portions 34b are not twisted in the twisting step. As shown in FIG. 1, the power-line-connection protruding portions 34b consist of three power-line-connection protruding portions 34b in the stator 10 as a whole. The three power-line-connection protruding portions 34b are provided for the respective U-phase, V-phase and W-phase, and are connected at their respective distal end portions 36b to the power lines 16 by welding or the like.

The protruding portions 34 include three small-twisted protruding portions 34a in addition to the three power-line-connection protruding portions 34b. Each of the three small-twisted protruding portions 34a is adjacent to a corresponding one of the three power-line-connection protruding portions 34b in the circumferential direction around the axis C, such that each of the three small-twisted protruding portions 34a is located on a front side of the corresponding one of the three power-line-connection protruding portions 34b in the twist direction, namely, on right side of the corresponding one of the three power-line-connection protruding portions 34b as seen in FIGS. 3 and 4. As is clear from FIG. 4, the small-twisted protruding portions 34a are twisted by a second twist angle Φ2 that is smaller than a first twist angle Φ1 by which the other protruding portions 34 (that are other than the small-twisted protruding portions 34a and the power-line-connection protruding portions 34b) are twisted. The second twist angle Φ2 is smaller than the first twist angle Φ1 by the slot interval angle θs. That is, a relationship between the first twist angle Φ1 of the other protruding portions 34 and the second twist angle Φ2 of the small-twisted protruding portions 34a is expressed by 12=Φ1−θs. In the present embodiment, the first twist angle Φ1 is equal to 3θs while the second twist angle Φ2 is equal to 2θs. The three small-twisted protruding portions 34a are provided for connecting between U1 phase and U2 phase, between V1 phase and V2 phase and between W1 phase and W2 phase. Like the distal end portions 36 of the other protruding portions 34, each of distal end portions 36a of the small-twisted protruding portions 34a is jointed to a radially adjacent distal end portion 36, such that the jointed distal end portions 36 belong to the respective coil segments 24 that are other than each other. As is clear from FIG. 3, the small-twisted protruding portions 34a protrude from the stator core 12 by a protruding distance that is smaller than a protruding distance of the other protruding portions 34, by an amount corresponding to the difference between the second twist angle Φ2 and the first twist angle Φ1(Φ2<Φ1). A length of the straight extending portions 30 of the coil segments 24 including the small-twisted protruding portions 34a is smaller than a length of the straight extending portions 30 of the other coil segments 24.

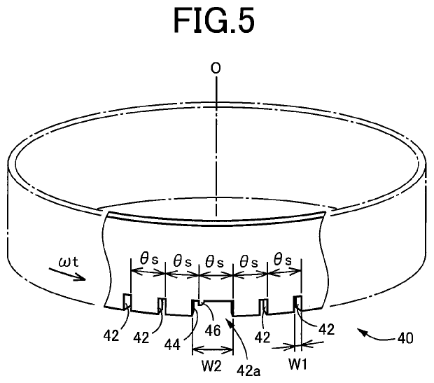

When the stator 10 shown in FIG. 1 is to be manufactured, the twisting step is required to twist the protruding portions 34 and the small-twisted protruding portions 34a such that the protruding portions 34 are twisted by the first twist angle Φ1 and such that the small-twisted protruding portions 34a are twisted by the second twist angle Φ2 that is smaller than the first twist angle Φ1 by the slot interval angle θs, as shown in FIGS. 3 and 4. FIG. 5 is a perspective view of a crown-shaped tool 40 as a tubular-shaped tool, which is used to concurrently twist the protruding portions 34 and the small-twisted protruding portions 34a, and shows specifically a part of the crown-shaped tool 40 for twisting four of the protruding portions 34 and one of the small-twisted protruding portions 34a, which are shown in FIGS. 3 and 4. The crown-shaped tool 40 has a cylindrical tubular shape, and is to be positioned relative to the stator core 12 such that the crown-shaped tool 40 is coaxial with the stator core 12, namely, an axis O of the crown-shaped tool 40 is aligned with the axis C of the stator core 12. The crown-shaped tool 40 has a multiplicity of engaging grooves 42, 42a that are provided in one of its axially opposite end portions, i.e., its axial end portion (lower end portion as seen in FIG. 5) that is to be opposed to the stator core 12, such that the engaging grooves 42, 42a are spaced apart from each other in a circumferential direction of the crown-shaped tool 40. The engaging grooves 42, 42a are grooves into which the distal end portions 36, 36a of the respective protruding portions 34, 34a are to be inserted. The crown-shaped tool 40 has a diameter substantially equal to a diameter that is defined by radially outer end portions of the respective slots 22 from which the protruding portions 34, 34a protrude. The engaging grooves 42, 42a are spaced apart from each other in the circumferential direction around the axis O by the slot interval angle θs. That is, the engaging grooves 42, 42a are spaced apart from each other at the same angular interval as the slots 22 and the protruding portions 34, 34a.

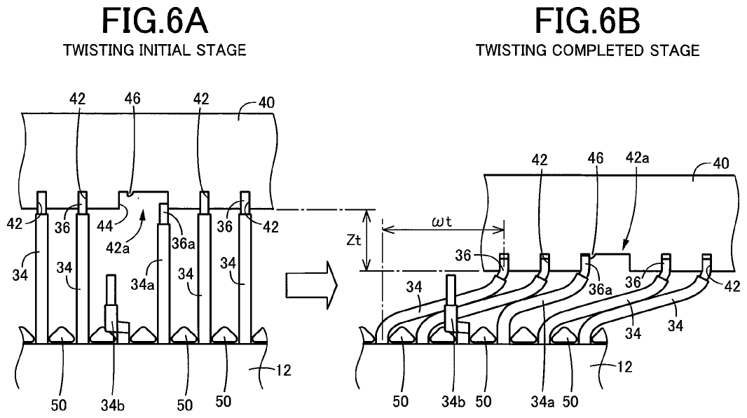

The crown-shaped tool 40 is positioned coaxially with the stator core 12, such that the distal end portions 36 of the respective protruding portions 34 are to be inserted in the engaging grooves 42 of the crown-shaped tool 40, with the distal end portions 36a of the respective small-twisted protruding portions 34a as ones of the protruding portions 34 being to be inserted in small-twisting engaging grooves 42a as ones of the engaging grooves 42. Then, the crown-shaped tool 40 is spirally rotated relative to the stator core 12, more specifically, the crown-shaped tool 40 is rotated about the axis C relative to the stator core 12 in counterclockwise direction by a predetermined twisting rotation angle wt that is equal to the first twist angle Φ1 (=30s), and is moved toward the stator core 12 in a Z-axis direction, i.e., the axial direction, by a predetermined axial distance Zt, such that the protruding portions 34 are concurrently twisted about the axis C by the first twist angle Φ1, except the small-twisted protruding portions 34a that are twisted about the axis C by the second twist angle 12, as shown in FIG. 4. In this instance, the protruding portions 34 are twisted while being engaged with the engaging grooves 42 and constrained by the engaging grooves 42, except the small-twisted protruding portions 34a that are twisted while being engaged with the small-twisting engaging grooves 42a and constrained by the small-twisting engaging grooves 42a. FIG. 6 is a set of views for explaining the twisting step in which the protruding portions 34, 34a are twisted by the crown-shaped tool 40. In FIG. 6, (a) TWISTING INITIAL STAGE shows a twisting initial stage in which the crown-shaped tool 40 is positioned coaxially with the stator core 12, with the distal end portions 36, 36a of the protruding portions 34, 34a being inserted in the engaging grooves 42, 42a of the crown-shaped tool 40. In the present embodiment, the distal end portions 36a of the small-twisted protruding portions 34a, as well as the distal end portions 36 of the other protruding portions 34 inserted in the engaging proves 42, are inserted in the small-twisting engaging grooves 42a, in the twisting initial stage shown in FIG. 6. However, in this twisting initial stage, the distal end portions 36a of the small-twisted protruding portions 34a may not yet be inserted in the small-twisting engaging grooves 42a.

In FIG. 6, (b) TWISTING COMPLETED STAGE shows a twisting completed stage in which the protruding portions 34 engaged with the engaging grooves 42 have been twisted by the first twist angle Φ1 while the small-twisted protruding portions 34a engaged with the small-twisting engaging grooves 42a have been twisted by the second twist angle 12, with the crown-shaped tool 40 being rotated about the axis C by twisting rotation angle wt and being axially moved toward the stator core 12 by the axial distance Zt, from the twisting initial stage. As shown in FIG. 6, a cuff support 50 is provided between each adjacent two of the protruding portions 34, 34a, for regulating a twisted shape of a proximal end portion of a corresponding one of the protruding portions 34, 34a protruding from the stator core 12, in the twisting step. In the present embodiment, the cuff support 50 is removed after the twisting step. However, the cuff support 50 may remain as a part of the stator 10 even after the twisting step.

Each of the engaging grooves 42, in which the distal end portions 36 of the protruding portions 34 are inserted, has a first groove width W1 as measured in the circumferential direction. The first groove width W1 is substantially equal to a width of each of the distal end portions 36 of the protruding portions 34, so that the twisting step is executed with the distal end portions 36 being constrained by the engaging grooves 42 to be substantially parallel to the axis C, whereby each of the protruding portions 34 is given a desired shape, as shown in (b) TWISTING COMPLETED STAGE in FIG. 6. The above-described axial distance Zt and a rate (speed) of the axial movement of the crown-shaped tool 40 relative to the stator core 12 are determined such that the twisting step can be performed with the distal end portions 36 inserted in the engaging grooves 42 being kept constrained by the engaging grooves 42. Meanwhile, the small-twisting engaging grooves 42a, in which the distal end portions 36a of the small-twisted protruding portions 34a are inserted, are provided to twist the small-twisted protruding portions 34a by the second twist angle Φ2 (=2θs) in the twisting step in which the crown-shaped tool 40 is rotated by the twisting rotation angle wt relative to the stator core 12 while being axially moved toward the stator core 12 by the axial distance Zt. Each of the small-twisting engaging grooves 42a has a second groove width W2 as measured in the circumferential direction. The second groove width W2 is larger than the first groove width W1 of the other engaging grooves 42 by the slot interval angle θs, and extends in leftward direction as seen in FIG. 6, i.e., in a direction opposite to the twist direction. Thus, while the crown-shaped tool 40 is being rotated from the twisting initial stage by less than the slot interval angle θs, the small-twisting engaging grooves 42a are rotated without forcing the small-twisted protruding portions 34a, so that the small-twisted protruding portions 34a are kept vertically extending as shown in (a) TWISTING INITIAL STAGE in FIG. 6. When the crown-shaped tool 40 has been rotated from the twisting initial stage by the slot interval angle θs, engaging surfaces 44 (see FIGS. 5 and 6) of the small-twisting engaging grooves 42a are brought into engagement with the distal end portions 36a of the small-twisted protruding portions 34a, so that the distal end portions 36a of the small-twisted protruding portions 34a start to be twisted in rightward direction as seen in FIG. 6, by further rotation of the crown-shaped tool 40. Each of the engaging surfaces 44 is constituted by one of side surfaces of a corresponding one of the small-twisting engaging grooves 42a which are opposite to each other in the circumferential direction, i.e., a rear one of the circumferentially opposite side surfaces in a rotating direction of the crown-shaped tool 40.

The small-twisting engaging grooves 42a have respective positioning protrusions 46 provided in groove bottoms thereof, such that each of the positioning protrusions 46 is spaced apart from a corresponding one of the engaging surfaces 44 of the small-twisting engaging grooves 42a by a distance corresponding to the width of each of the distal end portions 36a of the small-twisted protruding portions 34a. Therefore, when the crown-shaped tool 40 has been rotated relative to the stator core 12 by the slot interval angle θs from the twisting initial stage, the distal end portions 36a of the small-twisted protruding portions 34a are inserted between the engaging surfaces 44 and the positioning protrusions 46 so as to be positioned in a predetermined position relative to the crown-shaped tool 40, whereby the small-twisted protruding portions 34a are twisted with the distal end portions 36a of the small-twisted protruding portions 34a being constrained between the engaging surfaces 44 and the positioning protrusions 46. Since each of the engaging surfaces 44 and a corresponding one of the positioning protrusions 46 are spaced apart from each other by the distance substantially the same as the width of each of the distal end portions 36a of the small-twisted protruding portions 34a, as described above, the twisting step is executed with the distal end portions 36a being constrained by the engaging surfaces 44 and the positioning protrusions 46 to be substantially parallel to the axis C, whereby each of the small-twisted protruding portions 34a as well as each of the protruding portions 34 is given a desired shape, as shown in (b) TWISTING COMPLETED STAGE in FIG. 6. That is, with the crown-shaped tool 40 being rotated by the slot interval angle θs from the twisting initial stage, the small-twisted protruding portions 34a are brought into engagement with the engaging surfaces 44, and the distal end portions 36a of the small-twisted protruding portions 34a are inserted between the engaging surfaces 44 and the positioning protrusions 46 so as to be constrained therebetween. Then, with the crown-shaped tool 40 being further rotated by an angle 20s that is twice as large as the slot interval angle θs, and being further axially moved toward the stator core 12, the small-twisted protruding portions 34a are twisted by the second twist angle Φ2 (=2θs) so as to be given desired shapes, as shown in (b) TWISTING COMPLETED STAGE in FIG. 6. The above-described axial distance Zt and the rate (speed) of the axial movement of the crown-shaped tool 40 relative to the stator core 12 are determined such that the twisting step can be performed for the small-twisted protruding portions 34a, with the distal end portions 36 of the protruding portions 34 inserted in the engaging grooves 42 being kept constrained by the engaging grooves 42, and also with the distal end portions 36a of the small-twisted protruding portions 34a inserted between the engaging surfaces 44 and the positioning protrusions 46 of the small-twisting engaging grooves 42a being kept constrained therebetween. It is possible to change a rotational speed of the crown-shaped tool 40 about the axis C and the rate (speed) of the axial movement of the crown-shaped tool 40, as needed.

In the manufacturing method according to the present embodiment is executed by using the crown-shaped tool 40 having the engaging grooves 42 which have the first groove width W1, except the small-twisting engaging grooves 42a which have the second groove width W2 larger than the first groove width W1, such that the distal end portions 36 of the respective protruding portions 34 are to be inserted in the engaging grooves 42 of the crown-shaped tool 40, and such that the distal end portions 36a of the respective small-twisted protruding portions 34a are to be inserted in the small-twisting engaging grooves 42a. With the crown-shaped tool 40 being rotated relative to the stator core 12 and being moved toward the stator core 12 in the axial direction, the protruding portions 34 are concurrently twisted by the first twist angle Φ1, except the small-twisted protruding portions 34a that are twisted by the second twist angle 12. That is, where the protruding portions 34 include the small-twisted protruding portions 34a that are to be twisted by the twist angle 1 smaller than the other protruding portions 34, all of the protruding portions 34 including the small-twisted protruding portions 34a can be concurrently twisted by using the crown-shaped tool 40 as a tool common to all of the protruding portions 34, without need of a preforming step, so that the manufacturing cost can be suppressed owing to reductions of required tools and required manufacturing steps.

Further, the small-twisting engaging grooves 42a have the respective positioning protrusions 46 provided in the groove bottoms thereof, so that, when the crown-shaped tool 40 has been rotated relative to the stator core 12 by the slot interval angle θs, the distal end portions 36a of the respective small-twisted protruding portions 34a are inserted between the engaging surfaces 44 and the positioning protrusions 46 and are twisted with the distal end portions 36a of the respective small-twisted protruding portions 34a being constrained between the engaging surfaces 44 and the positioning protrusions 46. Thus, the small-twisted protruding portions 34a including the distal end portions 36a can be appropriately twisted to have desired shapes.

The above-identified Japanese Patent Application Publication (JP-2020-110025A) discloses a process in which the preforming step is executed to twist the small-twisted protruding portions 34a by the slot interval angle θs in a direction opposite to the twist direction, and after the preforming step, the protruding portions 34 and the small-twisted protruding portions 34a are concurrently twisted in the twist direction by the first twist angle Φ1 by using the crown-shaped tool. However, in this conventional process, the small-twisted protruding portions 34a are slid reciprocatively in the engaging grooves of the crown-shaped tool, so that the crown-shaped tool could be easily worn and accordingly the tool is likely to be frequently replaced with a new one. On the other hand, in the present embodiment, there is no substantial slide motion between the small-twisted protruding portions 34a and the small-twisting engaging grooves 42a of the crown-shaped tool 40, so that the crown-shaped tool 40 has an improved durability, and accordingly the manufacturing cost can be suppressed in this aspect, too. Further, in the present embodiment, since the small-twisted protruding portions 34a can be simply twisted by the second twist angle 12, it is possible to suppress occurrence of wrinkles in the small-twisted protruding portions 34a, for example, and to improve the product quality. Further, it is possible to reduce a required length of the small-twisted protruding portions 34a, so that the manufacturing cost can be reduced by reduction of use of copper material and the cost performance can be improved by reduction material loss.

While the preferred embodiment of this invention has been described in detail by reference to the drawings, it is to be understood the embodiment described above is given for illustrative purpose only, and that the present invention may be embodied with various modifications and improvements which may occur to those skilled in the art.

### NOMENCLATURE OF ELEMENTS

10: stator (stator for rotary electric machine)
12: stator core
14: stator coil
22: slot
24: coil segment
30: straight extending portion
34: protruding portion
34a: small-twisted protruding portion
36, 36a: distal end portion
40: crown-shaped tool (tubular-shaped tool)
42: engaging groove
42a: small-twisting engaging groove
44: engaging surface
46: positioning protrusion
MG: rotary electric machine
C: axis
θs: slot interval angle
Φ1: first twist angle
Φ2: second twist angle
W1: first groove width
W2: second groove width

What is claimed is:

1. A method of manufacturing a stator for a rotary electric machine, the stator including: (i) a stator core having a tubular shape and provided with a multiplicity of slots that are formed in an inner peripheral portion of the stator core such that the slots extend in an axial direction of the stator core and are spaced apart from each other at a constant angular interval in a circumferential direction of the stator core; and (ii) a multiplicity of coil segments each having a generally U shape so as to include a pair of straight extending portions that are received in respective different ones of the slots such that the straight extending portions include respective protruding portions protruding from the slots in the axial direction, wherein the protruding portions of the respective straight extending portions of the multiplicity of coil segments are twisted about an axis of the stator core by a predetermined first twist angle, except small-twisted protruding portions which are ones of the protruding portions and which are twisted about the axis by a predetermined second twist angle that is smaller than the first twist angle by a slot interval angle corresponding to the constant angular interval of the slots, and wherein distal end portions of the respective protruding portions of the respective coil segments are joined to each other, whereby a stator coil is formed,
the method being executed by using a tubular-shaped tool having a multiplicity of engaging grooves which are spaced apart from each other in a circumferential direction of the tubular-shaped tool, and which have a first groove width as measured in the circumferential direction of the tubular-shaped tool, except small-twisting engaging grooves which are ones of the engaging grooves and which have a second groove width as measured in the circumferential direction of the tubular-shaped tool, such that the second groove width is larger than the first groove width, and such that the small-twisting engaging grooves have respective engaging surfaces,
the method comprising:
positioning the tubular-shaped tool coaxially with the stator core, such that the distal end portions of the respective protruding portions are to be inserted in the engaging grooves of the tubular-shaped tool, and such that the distal end portions of the respective small-twisted protruding portions as the ones of the protruding portions are to be inserted in the small-twisting engaging grooves as the ones of the engaging grooves, and
rotating the tubular-shaped tool about the axis relative to the stator core and moving the tubular-shaped tool toward the stator core in the axial direction, such that the protruding portions are concurrently twisted about the axis by the first twist angle, except the small-twisted protruding portions that are twisted about the axis by the second twist angle,
wherein, when the tubular-shaped tool has been rotated relative to the stator core by the slot interval angle, the protruding portions are twisted by the first twist angle with the protruding portions being engaged with the engaging grooves, except the small-twisted protruding portions that are twisted by the second twist angle with the small-twisted protruding portions being engaged with the engaging surfaces of the small-twisting engaging grooves.

2. The method according to claim 1,
wherein the small-twisting engaging grooves have respective positioning protrusions provided in groove bottoms thereof, such that each of the positioning protrusions is spaced apart from a corresponding one of the engaging surfaces of the small-twisting engaging grooves by a distance corresponding to a width of each of the distal end portions of the respective small-twisted protruding portions,
wherein, when the tubular-shaped tool has been rotated relative to the stator core by the slot interval angle, the distal end portions of the respective small-twisted protruding portions are inserted between the engaging surfaces and the positioning protrusions so as to be positioned in a predetermined position relative to the tubular-shaped tool, whereby the small-twisted protruding portions are twisted with the distal end portions of the respective small-twisted protruding portions being constrained between the engaging surfaces and the positioning protrusions.

3. A tubular-shaped tool to be used for manufacturing a stator for a rotary electric machine, the stator including: (i) a stator core having a tubular shape and provided with a multiplicity of slots that are formed in an inner peripheral portion of the stator core such that the slots extend in an axial direction of the stator core and are spaced apart from each other at a constant angular interval in a circumferential direction of the stator core; and (ii) a multiplicity of coil segments each having a generally U shape so as to include a pair of straight extending portions that are received in respective different ones of the slots such that the straight extending portions include respective protruding portions protruding from the slots in the axial direction, wherein the protruding portions of the respective straight extending portions of the multiplicity of coil segments are twisted about an axis of the stator core by a predetermined first twist angle, except small-twisted protruding portions which are ones of the protruding portions and which are twisted about the axis by a predetermined second twist angle that is smaller than the first twist angle by a slot interval angle corresponding to the constant angular interval of the slots, and wherein distal end portions of the respective protruding portions of the respective coil segments are joined to each other, whereby a stator coil is formed,
the tubular-shaped tool comprising a multiplicity of engaging grooves which are spaced apart from each other in a circumferential direction of the tubular-shaped tool, and which have a first groove width as measured in the circumferential direction of the tubular-shaped tool, except small-twisting engaging grooves which are ones of the engaging grooves and which have a second groove width as measured in the circumferential direction of the tubular-shaped tool, such that the second groove width is larger than the first groove width, and such that the small-twisting engaging grooves have respective engaging surfaces,
wherein the tubular-shaped tool is to be positioned coaxially with the stator core such that the distal end portions of the respective protruding portions are to be inserted in the engaging grooves of the tubular-shaped tool, and such that the distal end portions of the respective small-twisted protruding portions as the ones of the protruding portions are to be inserted in the small-twisting engaging grooves as the ones of the engaging grooves, and is to be rotated about the axis relative to the stator core and moved toward the stator core in the axial direction, such that the protruding portions are concurrently twisted about the axis by the first twist angle, except the small-twisted protruding portions that are twisted about the axis by the second twist angle,
wherein, when the tubular-shaped tool has been rotated relative to the stator core by the slot interval angle, the protruding portions are twisted by the first twist angle with the protruding portions being engaged with the engaging grooves, except the small-twisted protruding portions that are twisted by the second twist angle with the small-twisted protruding portions being engaged with the engaging surfaces of the small-twisting engaging grooves,
wherein the small-twisting engaging grooves have respective positioning protrusions provided in groove bottoms thereof, such that each of the positioning protrusions is spaced apart from a corresponding one of the engaging surfaces of the small-twisting engaging grooves by a distance corresponding to a width of each of the distal end portions of the respective small-twisted protruding portions,
wherein, when the tubular-shaped tool has been rotated relative to the stator core by the slot interval angle, the distal end portions of the respective small-twisted protruding portions are inserted between the engaging surfaces and the positioning protrusions so as to be positioned in a predetermined position relative to the tubular-shaped tool.

4. The tubular-shaped tool according to claim 3,
wherein the second groove width of the small-twisting engaging grooves is larger than the first groove width of the engaging grooves by a width corresponding to the slot interval angle.
